(19) United States
(12) Patent Application Publication
(10) Pub. No.: US 2014/0112355 A1
(43) Pub. Date: Apr. 24, 2014

(54) Method, Apparatus and System for Transmitting Traffic Indication Message

(71) Applicant: Huawei Device Co., Ltd., Shenzhen (CN)

(72) Inventors: Ping Fang, Shenzhen (CN); Zhiming Ding, Shenzhen (CN); Guiming Shu, Shenzhen (CN); Yi Luo, Shenzhen (CN)

(73) Assignee: Huawei Device Co., Ltd., Shenzhen (CN)

(21) Appl. No.: 14/138,438

(22) Filed: Dec. 23, 2013

Related U.S. Application Data
(63) Continuation of application No. PCT/CN2013/070297, filed on Jan. 10, 2013.

(30) Foreign Application Priority Data
Jan. 11, 2012 (CN) 201210008652.0

(51) Int. Cl. H04L 12/811

(52) U.S. Cl. CPC H04L 47/38
USPC 370/477

(57) ABSTRACT

A method, an apparatus, and a system for transmitting a traffic indication message, which relate to a wireless fidelity (WiFi) technology and are mainly applicable to a traffic indication message processing procedure. The method includes: compressing a delivery traffic indication message, and generating a traffic indication message; and transmitting the traffic indication message, where the traffic indication message includes compression method indication information and the compressed delivery traffic indication message.

### CROSS-REFERENCE TO RELATED APPLICATIONS

This application is a continuation of International Application No. PCT/CN2013/070297, filed on Jan. 10, 2013, which claims priority to Chinese Patent Application No. 201210008652.0, filed on Jan. 11, 2012, both of which are hereby incorporated by reference in their entireties.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present invention relates to the field of wireless communications, and in particular, to an access control method for a wireless fidelity (WiFi) device and a WiFi device.

### BACKGROUND OF THE INVENTION

As a short-range wireless communications technology, the WiFi technology has gained wide application in wireless local area network construction and wide area network access due to its advantages such as convenient use and a high transmission rate. Nowadays, many public places such as airport lounges and coffee shops are equipped with access points (APs) for WiFi.

In a WiFi wireless network, when a Station (STA) (e.g. a terminal device supporting 802.11 protocols) accesses the network, the STA needs to establish association with an AP first, and then AP assigns an association identifier (ID) (AID) to the STA. After that, the AP periodically broadcasts a beacon frame which includes a traffic indication message (TIM), and the TIM carries identifiers which indicate whether all STAs associated with the AP have data to deliver. The identifier is used to notify the STA of whether the STA has data to receive. By periodically receiving a Beacon message, the STA obtains a value of a bit corresponding to the AID of the STA in a bitmap of the TIM message, and thereby determines whether the STA has data to receive; if the value is one, it indicates that the STA has data to receive; and if the value is zero, it indicates that the STA has no data to receive. If the STA has data to receive, the STA requests the AP to transmit the data or waits for the AP to transmit the data; and if the STA has no data to receive, the STA may enter a power-saving mode and wakes up at the moment when a next Beacon is transmitted to receive the next Beacon.

A format of the TIM message is shown in FIG. 1. TIM information may be used for indicating whether at most 2007 STAs have delivery traffic indication messages (DTIMs). Definitions of the fields in FIG. 1 are as follows: element ID indicates the type of a message; message length indicates the length of a transmitted TIM message; broadcast message count (e.g. DTIM Count) indicates how many beacons are to be transmitted before a next DTIM, and zero indicates that the TIM is a DTIM; broadcast message period (e.g. DTIM Period) indicates the number of Beacons transmitted between two successive DTIMs; if all TIMs are DTIMs, the bit is set to one, and the bit is never zero; in bitmap control, B0 is a message indication bit for AID0, and when the AP has broadcast data to transmit to all STAs, the bit is one; otherwise, the bit is zero; B1 to B7 indicate bitmap offsets; and partial virtual bitmap indicates an indication bit which indicates whether each corresponding STA has data to transmit; if a STA has data to transmit, the bit is one; otherwise, the bit is zero.

As shown in FIG. 2, bits in the Partial Virtual Bitmap are corresponding to AIDs, that is, corresponding to STAs. When a corresponding bit value is one, it indicates that the AP has data to transmit to a corresponding STA. For example, when a bit value of AID2 is one, it indicates that the AP has data to transmit to STA2. Among the AIDs, AID0 is reserved to indicate whether the AP has broadcast data to transmit to all the STAs. The AID0 is not assigned to any STA, that is, the bit B0 in the Bitmap Control indicates the AID0. The Bitmap Offset in the Bitmap Control is used to indicate how many successive bytes are zero before a value one in the Partial Virtual Bitmap. As shown in FIG. 2, the STAs corresponding to AID2, AID7, AID22, and AID24 in the Partial Virtual Bitmap all have data to receive.

In the partial virtual bitmap, an AID corresponding to each STA takes up one bit. When a large number of zeroes exist in the partial virtual bitmap, an existing compression method is to compress zeroes in the front and zeroes in the rear, that is, use both seven bits from B1 to B7 in the Bitmap Control field and the Length field in the TIM message to compress the partial virtual bitmap. When bytes in the front of the partial virtual bitmap are zeroes, the bytes may be skipped through indication of the Bitmap Control field. As the Bitmap Control field has a limited number of bits (namely, seven bits), a value of the Bitmap Control field indicates the number of skipped doubt-bytes (namely, 16 bits). As for bytes which are zeroes in the rear of the partial virtual bitmap, the bytes may be truncated by assigning a value to the Length field.

As shown in FIG. 3, in the partial virtual bitmap, the first 16 bits (altogether two bytes) are all zeroes, and the rear bytes from the 1008^{th} bit to the last bit (altogether 125 bytes) are all zeroes; therefore, B7 in the Bitmap Control field is one, which indicates that two bytes are skipped. That is, the AIDs in the partial virtual bitmap start from 16, and the Length field is 128, because 256 bytes minus one byte of the Element ID is 255 bytes, and 255 bytes minus the skipped first two bytes and the truncated rear 125 bytes is 128 bytes. For the compression method in existing standards, if non-successive ones appear in the middle of the partial virtual bitmap, for example, a bit corresponding to AID1 is one, a bit corresponding to AID2007 is one, and bits corresponding to AIDs between the two AIDs are all zeroes, the compression cannot be implemented; therefore, a large number of bits are wasted.

In the process of implementing the present invention, the inventor finds that a WiFi extension standard being formulated specifically requires that an AP supports 6000 STAs or more. However, in the prior art, a single AP supports only 2007 STAs at most. When the AP supports a large number of STAs, the TIM message may increase in length according to an existing TIM organization manner. Besides, the existing compression method may not be able to effectively compress the TIM, leading to an increase in the length of a Beacon.

### SUMMARY OF THE INVENTION

Embodiments of the present invention provide a method, an apparatus, and a system for transmitting a traffic indication message, so as to implement effective compression of a TIM message, and reduce the length of the TIM message, thereby reducing the length of a Beacon, and increasing the transmission efficiency.

To fulfill the above objective, the embodiments of the present invention adopt the following technical solutions.

A method for transmitting a traffic indication message is provided, which includes: compressing a delivery traffic indication message, and generating a traffic indication message, where the delivery traffic indication message is used for indicating whether at least one terminal device associated with an access point has data to receive, and the delivery traffic indication message indicates, through a delivery traffic indication bit corresponding to the at least one terminal device, whether the at least one terminal device has data to receive; and transmitting the traffic indication message, where the traffic indication message includes compression method indication information and the compressed delivery traffic indication message, and the compression method indication information is used for indicating a compression method adopted to compress the delivery traffic indication message.

A method for receiving a traffic indication message is provided, which includes: receiving, by a first terminal device, a traffic indication message, where the traffic indication message includes compression method indication information and a compressed delivery traffic indication message corresponding to at least one terminal device associated with an access point, the compression method indication information is used for indicating a compression method adopted to compress the delivery traffic indication message corresponding to the at least one terminal device, and the delivery traffic indication message indicates, through a delivery traffic indication bit, whether the at least one terminal device has data to receive; and according to the compression method indicated by the compression method indication information in the received traffic indication message, decompressing the delivery traffic indication message in the received traffic indication message, and obtaining the delivery traffic indication bit corresponding to the first terminal device.

An access point is provided, which includes: a compressing unit configured to compress a delivery traffic indication message and generate a traffic indication message, where the delivery traffic indication message is used for indicating whether at least one terminal device associated with the access point has data to receive, and the delivery traffic indication message indicates, through a delivery traffic indication bit corresponding to the at least one terminal device, whether the at least one terminal device has data to receive; and a transmitting unit configured to transmit the traffic indication message, where the traffic indication message includes compression method indication information and the compressed delivery traffic indication message, and the compression method indication information is used for indicating a compression method adopted to compress the delivery traffic indication message.

A terminal device is provided, which includes: a receiving unit configured to receive a traffic indication message, where the traffic indication message includes compression method indication information and a compressed delivery traffic indication message corresponding to at least one terminal device associated with an access point, the compression method indication information is used for indicating a compression method adopted to compress the delivery traffic indication message corresponding to the at least one terminal device, and the delivery traffic indication message indicates, through a delivery traffic indication bit, whether the at least one terminal device has data to receive; and a decompressing unit configured to decompress, according to the compression method indicated by the compression method indication information in the received traffic indication message, the delivery traffic indication message in the received traffic indication message, and obtain the delivery traffic indication bit corresponding to the first terminal device.

A system for transmitting a traffic indication message is provided, which includes: the access point and the terminal device.

The method, apparatus, and system for transmitting a traffic indication message provided by the embodiments of the present invention compress a delivery traffic indication message corresponding to each terminal device, generate the traffic indication message, and then transmit the traffic indication message, thereby solving the problem that the TIM message is too long, reducing the length of a Beacon frame, and increasing the transmission efficiency.

### BRIEF DESCRIPTION OF THE DRAWINGS

FIG. 1 is a schematic diagram of a format of a traffic indication message in the prior art;

FIG. 2 is a usage exemplary diagram of a bitmap in the prior art;

FIG. 3 is an exemplary diagram of a compression method in the prior art;

FIG. 4 is a flow chart of operation steps of a method for transmitting a traffic indication message provided by Embodiment 1 of the present invention;

FIG. 5 is an exemplary diagram of basic elements of a multi-block compression method provided by Embodiment 1 of the present invention;

FIG. 6 is an exemplary diagram of a format of a TIM message provided by Embodiment 1 of the present invention;

FIG. 7 is an exemplary diagram of a delivery traffic indication message before bit flipping provided by Embodiment 1 of the present invention;

FIG. 8 is a flow chart of operation steps of a method for receiving a traffic indication message provided by Embodiment 2 of the present invention;

FIG. 9 is an operation flow chart of a method for transmitting a traffic indication message adopted when an access point sequentially transmits a traffic indication message corresponding to at least one terminal device group provided by Embodiment 3 of the present invention;

FIG. 10 is a schematic diagram of a format of a first type of group traffic indication message (GTIM) message in a method for transmitting a traffic indication message provided by Embodiment 3 of the present invention;

FIG. 11 is a schematic diagram of a format of a GTIM message when a multi-block compression method is adopted in a method for transmitting a traffic indication message provided by Embodiment 3 of the present invention;

FIG. 12 is an operation flow chart of a method for transmitting a traffic indication message adopted when an access point transmits a traffic indication message corresponding to all terminal device groups provided by Embodiment 3 of the present invention;

FIG. 13 is a schematic diagram of a format of a second type of GTIM message in a method for transmitting a traffic indication message provided by Embodiment 3 of the present invention;

FIG. 14 is a structural diagram of an access point provided by Embodiment 4 of the present invention;

FIG. 15 is a structural diagram of a compressing unit in an access point provided by Embodiment 4 of the present invention;

FIG. 16 is a structural diagram of a terminal device provided by Embodiment 4 of the present invention; and

FIG. 17 is a structural diagram of a system for transmitting a traffic indication message provided by Embodiment 4 of the present invention.

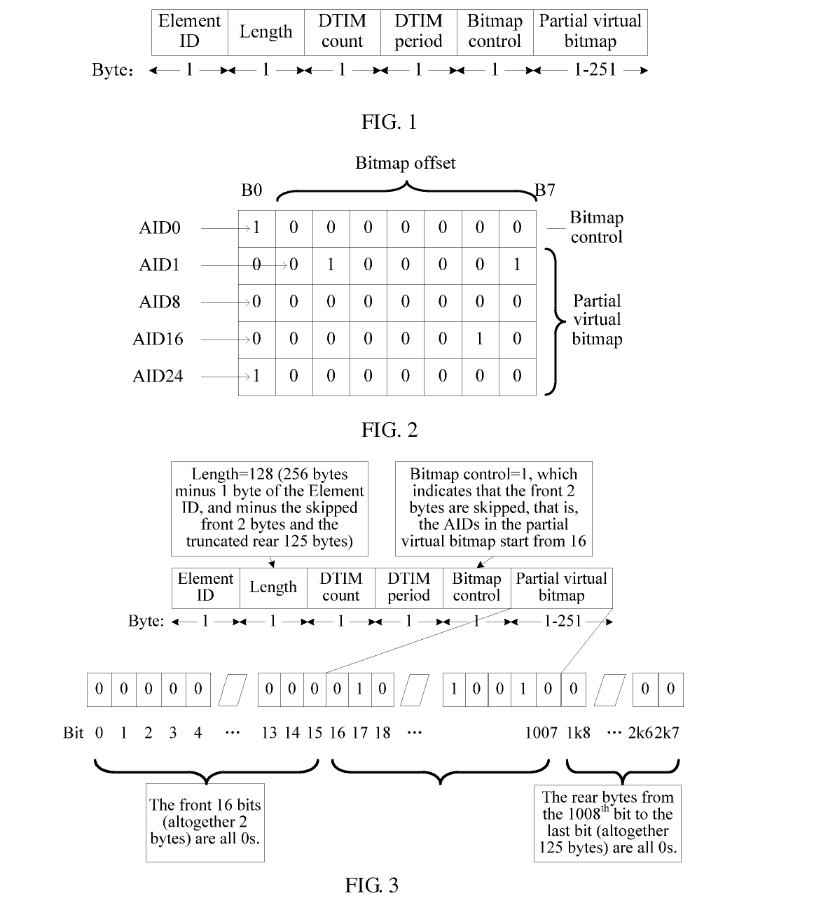

### DETAILED DESCRIPTION OF THE EMBODIMENTS

The following describes a method, an apparatus, and a system for transmitting a traffic indication message provided by the embodiments of the present invention in detail with reference to the accompanying drawings.

### Embodiment 1

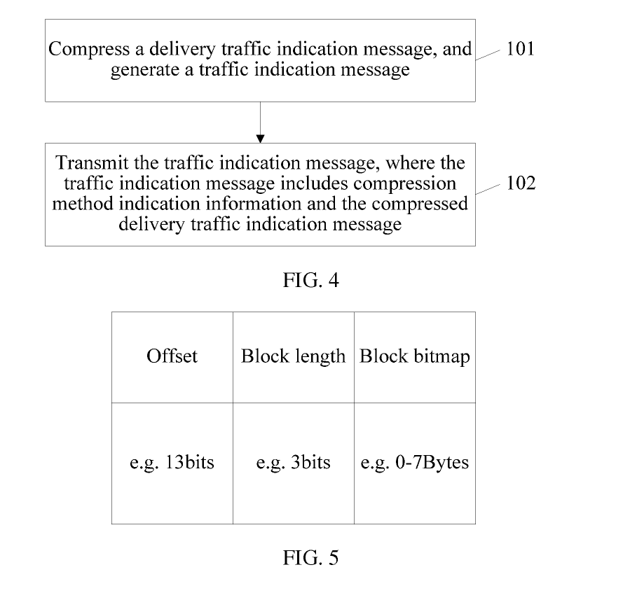

An embodiment of the present invention provides a method for transmitting a traffic indication message. As shown in FIG. 4, operation steps of an access point include:

Step 101: Compress a delivery traffic indication message, and generate a traffic indication message, where the delivery traffic indication message is used for indicating whether at least one terminal device associated with the access point has data to receive, and the delivery traffic indication message indicates, through a delivery traffic indication bit corresponding to the at least one terminal device, whether the at least one terminal device has data to receive.

Step 102: Transmit the traffic indication message, where the traffic indication message includes compression method indication information and the compressed delivery traffic indication message, and the compression method indication information is used for indicating a compression method adopted to compress the delivery traffic indication message.

The method for transmitting a traffic indication message provided by this embodiment of the present invention compresses a delivery traffic indication message corresponding to each terminal device, generates the traffic indication message, and then transmits the traffic indication message, thereby solving the problem that the TIM message is too long, reducing the length of a Beacon frame, and increasing the transmission efficiency.

In this specific application, compressing the delivery traffic indication message specifically includes: encoding a bitmap of the delivery traffic indication bit. Different compression methods, namely, encoding methods, may be adopted for encoding the bitmaps; and the compression methods are indicated by the compression method indication information in the traffic indication message.

The following provides a multi-block solution for compressing a delivery traffic indication message. As shown in FIG. 5, basic elements of a multi-block definition include an offset, a block length, and a bitmap. Specific definitions are as follows: offset indicates an AID of a first terminal device of which an indication bit is one in a block and may occupy 13 bytes; block length indicates the length of a block bitmap in the block; when the block length is zero, it indicates that there is no block bitmap information; therefore, the offset refers to only one AID; and the maximum block length is seven bytes, which occupy 3 bits; and block bitmap indicates a partial bitmap of one block; the maximum length of the bitmap is seven bytes, that is, one block indicates partial bitmaps of 56 terminal devices at most.

During the compressing of the TIM message, by using the multi-block solution the TIM is searched backwards, starting from AID1, for bits of which values are ones; when the first one is found, a value of an AID corresponding to the first one is filled in the Offset of the basic elements; if multiple ones appear within a range of several bytes (a range of seven bytes at most) after the first one in the TIM, bitmaps including the several bytes of which values are ones in the TIM are copied to a block bitmap, where the length (in bytes) of the block bitmap is indicated by the block length; and if no other ones appear within the range of seven bytes after the first one, the block length is set to zero, which indicates that no bitmap exists after the first one. In this way, the first basic element for compression is obtained; then, the above steps are continuously performed to search for the first one appearing afterwards, and the above steps are repeated until the searching and encoding of the whole TIM is completed. After the whole TIM is compressed, multiple basic elements are obtained.

When the compression method is adopted, the compression method needs to be indicated in the compression method indication information of the TIM message, so that when receiving the compressed TIM message, the STA may decompress the TIM message according to an algorithm indicated by the compression method indication information, so as to obtain a corresponding delivery traffic indication message. For example, when three bits are adopted to indicate the compression method indication information, 000 may indicate adopting the existing method of compressing zeroes in the front and rear; 001 may indicate adopting the multi-block compression algorithm, and so on. Certainly, other compression algorithms may also be adopted to compress the TIM, and are indicated by the compression method indication information.

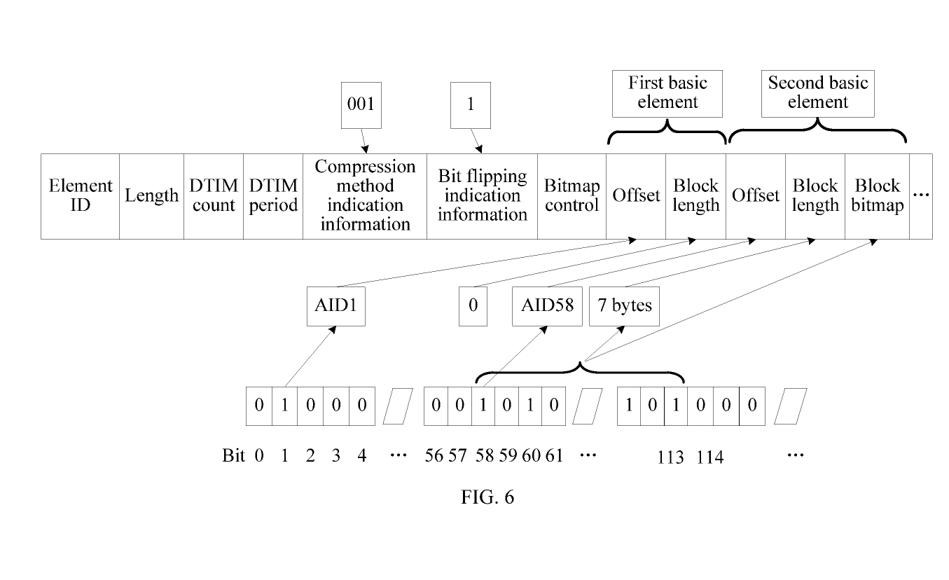

For example, as shown in FIG. 6, when the compression method indication information is 001, which indicates adopting the multi-block compression algorithm, a value of the AID1 in the TIM message is one, and no other ones appear within seven bytes after the one; therefore, the block length is set to zero, which indicates that no bitmap exists after the one. In this way, the first basic element for compression is obtained. When a value of AID58 is one, because multiple ones appear within the range of seven bytes after the one, Bitmaps including the seven bytes of which values are ones in the TIM are copied into the block bitmap of the basic element, where the length (in bytes) of the block bitmap is indicated by the block length in the basic elements, and the block length of the second basic element is seven bytes. Then, the above steps are continuously performed to search for the first one that appears afterwards, and the above steps are repeated until the searching and encoding of the whole TIM is completed. After the whole TIM is compressed, multiple basic elements are obtained.

Meanwhile, as shown in FIG. 6, the transmitted traffic indication message further includes bit flipping indication information, used for indicating whether bit flipping is performed on the delivery traffic indication bit in the delivery traffic indication message.

The bit flipping is used to invert ones to zeroes and invert zeroes to ones before compression when multiple ones appear in the TIM, thereby further improving the compression efficiency. The flipping may be performed on the whole TIM before the compression; in this case, the bit flipping indication information needs to be added to the TIM message and may be placed behind the compression method indication information. When a value of the indication information is zero, it indicates that the flipping is not performed; and when the value of the indication information is one, it indicates that the flipping is performed before the compression. Correspondingly, the flipping may also be used for partial Bitmap compression, and may be indicated by a corresponding indication bit.

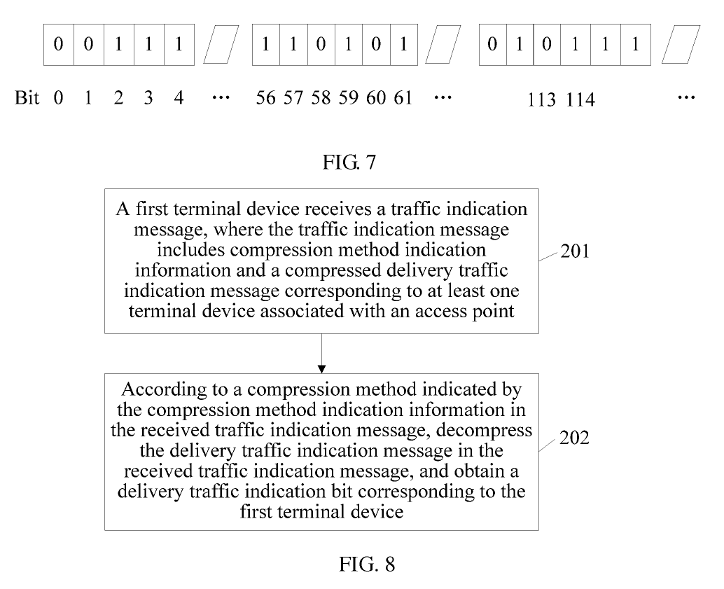

FIG. 7 shows an information situation of the TIM before the bit flipping is performed, and an information situation of the TIM after the bit flipping is performed is shown in FIG. 6.

### Embodiment 2

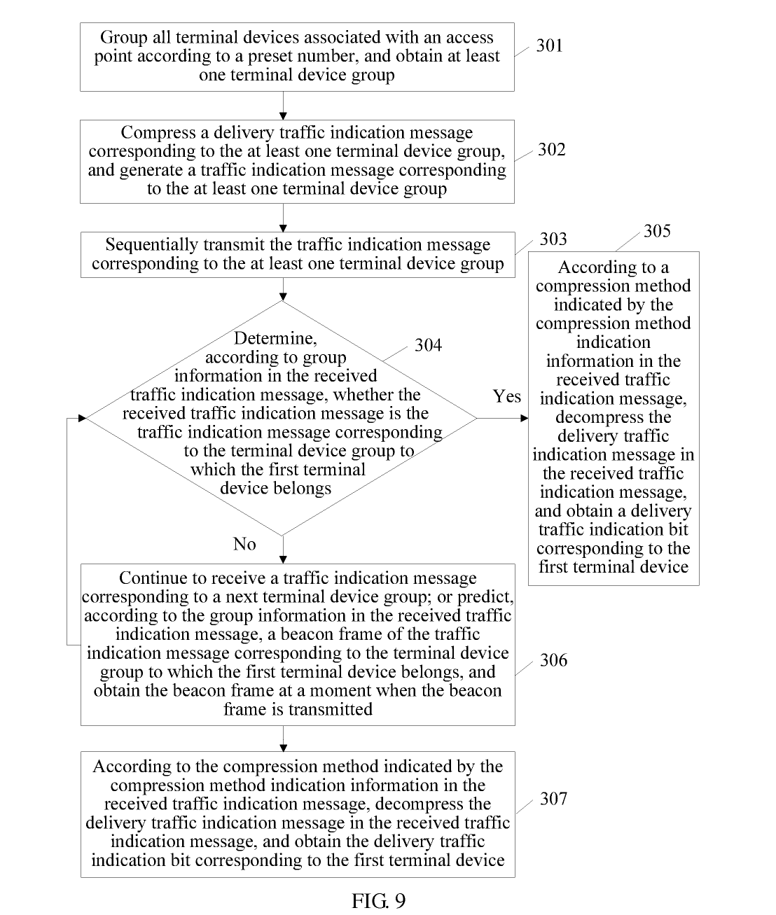

An embodiment of the present invention provides a method for receiving a traffic indication message. As shown in FIG. 8, operation steps of a terminal device include:

Step 201: A first terminal device receives a traffic indication message, where the traffic indication message includes compression method indication information and a compressed delivery traffic indication message corresponding to at least one terminal device associated with an access point, the compression method indication information is used for indicating a compression method adopted to compress the delivery traffic indication message corresponding to the at least one terminal device, and the delivery traffic indication message indicates, through a delivery traffic indication bit, whether the at least one terminal device has data to receive.

Step 202: According to the compression method indicated by the compression method indication information in the received traffic indication message, decompress the delivery traffic indication message in the received traffic indication message, and obtain the delivery traffic indication bit corresponding to the first terminal device.

In the method for receiving a traffic indication message provided by this embodiment of the present invention, the terminal device receives the traffic indication message, decompresses a delivery traffic indication message corresponding to the terminal device in the received traffic indication message, and obtains the delivery traffic indication bit corresponding to the terminal device, thereby solving the problem that the TIM message is too long, reducing the length of a Beacon frame, and increasing the transmission efficiency.

In this specific application, according to the compression method indication information in the received traffic indication message, decompression is performed on the delivery traffic indication message in the received traffic indication message, that is, a bitmap of the delivery traffic indication bit is decoded.

A compression algorithm indicated by the compression method indication information is shown in FIG. 6. According to FIG. 6, decompression is performed on the delivery traffic indication message corresponding to the terminal device in the received traffic indication message, that is, the bitmap of the delivery traffic indication bit is decoded.

Meanwhile, according to bit flipping indication information in the received traffic indication message, it is learned that whether bit flipping needs to be performed on the delivery traffic indication bit in the delivery traffic indication message.

As shown in FIG. 6, when the bit flipping indication information is one, bit flipping is performed on the obtained Bitmap after the decompression is performed on the received delivery traffic indication message according to the compression algorithm indicated by the compression method indication information, so as to invert ones to zeroes and invert zeroes to ones, and thereby corresponding delivery traffic indication information is obtained.

### Embodiment 3

An embodiment of the present invention provides a method for transmitting a traffic indication message. As shown in FIG. 9, specific steps are as follows:

Step 301: Group all terminal devices associated with an access point according to a preset number, and obtain at least one terminal device group.

The access point groups the terminal devices according to a preset fixed number.

For example, when the preset fixed number is 1500, every 1500 terminal devices form one group; therefore, terminal devices of which association IDs are from one to 1500 belong to a first terminal device group, terminal devices of which association IDs are from 1501 to 3000 belong to a second terminal device group, terminal devices of which association IDs are from 3001 to 4500 belong to a third terminal device group, and the rest can be deduced by analogy.

Step 302: Compress a delivery traffic indication message corresponding to the at least one terminal device group, and generate a traffic indication message corresponding to the at least one terminal device group, where the delivery traffic indication message is corresponding to one terminal device in the at least one terminal device group, and the at least one terminal device associated with the access point is specifically any terminal device in the terminal device group corresponding to the traffic indication message.

Different compression methods may be adopted to compress a delivery traffic indication messages corresponding to terminal devices in each terminal device group, and a compression method is indicated by compression method indication information in the traffic indication message corresponding to the terminal device group.

Step 303: Sequentially transmit the traffic indication message corresponding to the at least one terminal device group, where the traffic indication message further includes group information, the group information is group information used for indicating the terminal device group corresponding to the traffic indication message, and the delivery traffic indication message indicates, through a delivery traffic indication bit corresponding to each terminal device in the terminal device group corresponding to the delivery traffic indication message, whether each terminal device in the terminal device group corresponding to the delivery traffic indication message has data to receive.

The access point transmits a traffic indication message corresponding to an i^{th} terminal device group to all the terminal devices which access the access point. The group information in the traffic indication message may include a group period of the terminal device groups, and/or the number of terminals included in each terminal device group, a group index i, compression method indication information, and the compressed delivery traffic indication message corresponding to each terminal device in the terminal device group, where i is a positive integer, and 1≦i≦group period.

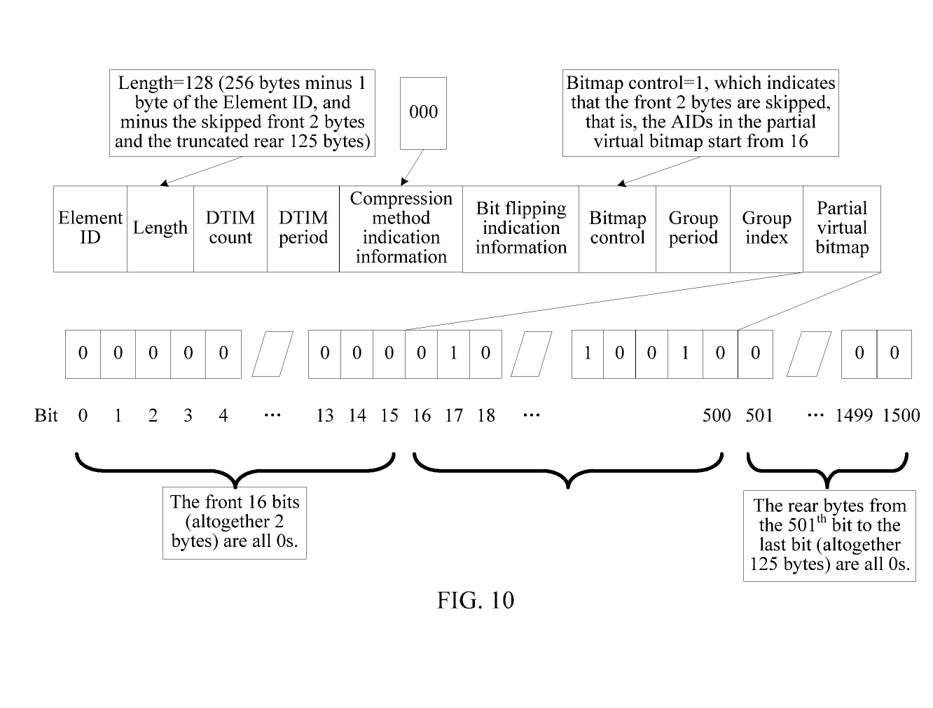

In this case, the traffic indication message corresponding to the terminal device group is GTIM. A format of a first type of GTIM message provided by an embodiment of the present invention is shown in FIG. 10. Each GTIM message includes a DTIM message, and newly defined fields in FIG. 10 are as follows: element ID indicates the type of a message, which is used for indicating that the message is a GTIM message; message length indicates the length of a transmitted GTIM message; compression method indication information indicates a method for compressing a delivery traffic indication message in a terminal device group; group period is used for indicating the total number of terminal device groups; and group index is used for indicating a group serial number of a terminal device group.

The group period and the group index may altogether occupy the first eight bits (each four bits) in an original partial virtual bitmap, and the compression method may occupy two or three bits in the original partial virtual bitmap; therefore, the partial virtual bitmap in the GTIM is reduced from the original 2008 bits to 1998 bits or 1997 bits, that is, the partial virtual bitmap may correspond to 1998 or 1997 terminal devices at most.

When the access point needs to support 6000 terminal devices, the preset fixed number is 1500; therefore, the group period is four. As the group period is four, the group index may be 1, 2, 3, or 4.

Because the traffic indication message corresponding to the terminal device group carries the delivery traffic indication message of the terminal device which accesses the access point, in the partial virtual bitmap, each bit is corresponding to a terminal device; when a message needs to be transmitted to a terminal device, a value of an indication bit corresponding to the terminal device is one; and when no message needs to be transmitted to the terminal device, the indication bit is zero. When plenty of zeroes exist, a great number of bits are wasted. An existing compression method is adopted to compress the delivery traffic indication message of each terminal device.

For example, when the compression method indication information takes up three bits, a compression method indicated by 000 is shown in FIG. 10; in the partial virtual bitmap, the first 16 bits (altogether two bytes) are all zeroes, and the rear bytes from the 501^{th} bit to the last bit (altogether 125 bytes) are all zeroes; therefore, B7 in the Bitmap Control field is one, which indicates that two bytes are skipped, that is, AIDs in the partial virtual bitmap start from 16. The Length field is 128, because 256 bytes minus one byte of the Element ID is 255 bytes, and 255 bytes minus the skipped first two bytes and the truncated rear 125 bytes is 128 bytes. When the compression method is adopted, in a situation that a bit corresponding to AID1 is one, a bit corresponding to AID2007 is also one, and bits corresponding to all AIDs between AID1 and AID2007 are all zeroes, a beneficial effect of compression cannot be achieved.

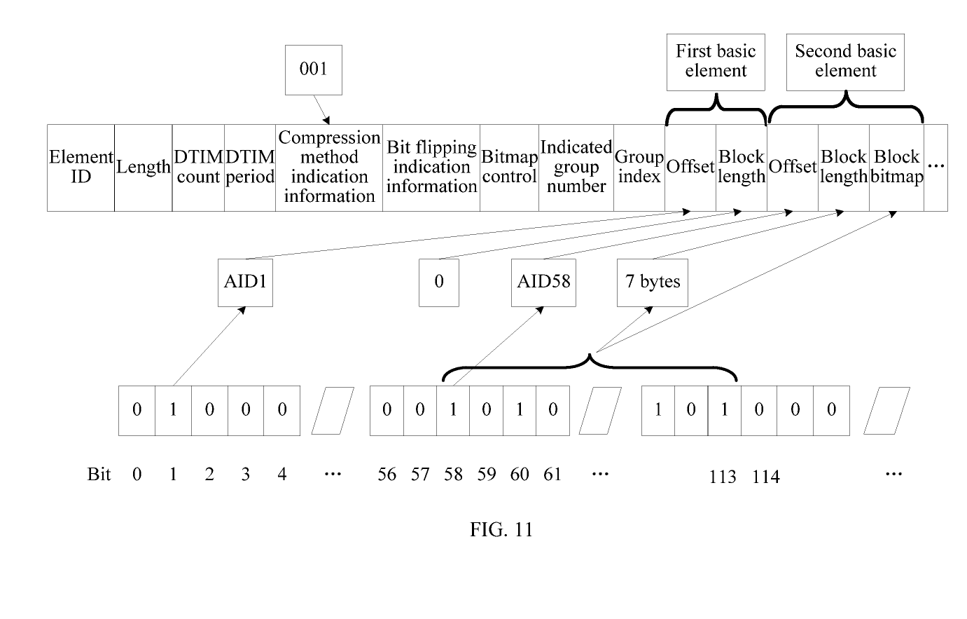

In response to the above situation, a multi-block compression method algorithm may be adopted. As shown in FIG. 11, at this time, the compression method indication bit information is 001, and the seven bits in the Bitmap Control field and the partial virtual bitmap are replaced by the block basic elements shown in FIG. 6.

The traffic indication message corresponding to the terminal device group may include a plurality of the above basic elements, and the sizes of the basic elements are not fixed.

In addition, there may be other compression methods, which may provide different compression effects in different distribution situations of zeroes and ones in the delivery traffic indication messages corresponding to the terminal devices in each terminal device group. Therefore, in order to increase the compression efficiency, different compression methods may be adopted for different terminal device groups, so as to achieve the best compression effect.

Meanwhile, as shown in FIG. 10 and FIG. 11, the transmitted traffic indication message corresponding to the terminal device group further includes bit flipping indication information, used for indicating whether bit flipping is performed on the delivery traffic indication bit in the delivery traffic indication message.

Beacon frames transmitted by the access point sequentially carry traffic indication messages corresponding to three terminal device groups in an order of group indexes of the terminal device groups, and the beacon frame transmitted each time carries a traffic indication message corresponding to one terminal device group.

Step 304: Determine, according to the group information in the received traffic indication message, whether the received traffic indication message is the traffic indication message corresponding to the terminal device group to which the first terminal device belongs.

The first terminal device receives the traffic indication message corresponding to the i^{th} terminal device group and transmitted by the access point. As described above, the group information in the traffic indication message may include a group period of the terminal device groups, and/or the number of terminal devices in each group, a group index i, compression method indication information, and the compressed delivery traffic indication message corresponding to each terminal device in the terminal device group, where i is a positive integer, and 1≦i≦group period.

It is determined whether the group index of the group to which the first terminal device belongs is equal to the group index of the i^{th} terminal device group.

A group index of a terminal device group to which a terminal device belongs may be obtained by: dividing an association ID of the terminal device by a preset fixed number to obtain a quotient, rounding the quotient to obtain an integer, and adding one to the integer.

For example, the association ID of the first terminal device is 14, and the preset fixed number is 1500; therefore, the group index of the group to which the first terminal device belongs is [14/2000]+1, that is, the group index of the group, to which the first terminal device with the association ID being 14 belongs, is one.

Step 305: When it is determined that the traffic indication message received by the first terminal device is the traffic indication message corresponding to the terminal device group to which the first terminal device belongs, according to the compression method indicated by the compression method indication information in the received traffic indication message, decompress the delivery traffic indication message in the received traffic indication message, and obtain the delivery traffic indication bit corresponding to the first terminal device.

When the group index of the group to which the first terminal device belongs is equal to the group index of the i^{th} terminal device group, the delivery traffic indication message corresponding to the terminal device in the i^{th} terminal device group is obtained.

For example, when the group index of the group, to which the first terminal device with the association ID being 14 belongs, is one, and the received traffic indication message is a traffic indication message corresponding to the first terminal device group, the terminal device obtains the delivery traffic indication message corresponding to the terminal device from the first terminal device group among the received terminal device groups.

Step 306: When it is determined, according to the group information in the received traffic indication message, that the received traffic indication message is not the traffic indication message corresponding to the terminal device group to which the first terminal device belongs, continue to receive a traffic indication message corresponding to a next terminal device group; or predict, according to the group information in the received traffic indication message, a beacon frame of the traffic indication message corresponding to the terminal device group to which the first terminal device belongs, and obtain the beacon frame at the moment when the beacon frame is sent.

When the group index of the group to which the first terminal device belongs is not equal to the group index of the i^{th} terminal device group, the first terminal device continues to receive a next beacon frame, where the next beacon frame includes a traffic indication message corresponding to an (i+1)^{th} terminal device group; or when the group index of the group to which the first terminal device belongs is not equal to the group index of the i^{th} terminal device group, the first terminal device predicts, according to the group period of the received terminal device groups, a beacon frame of the traffic indication message corresponding to the terminal device group to which the first terminal device belongs, and obtains the beacon frame at the moment when the beacon frame is sent.

For example, when the group index of the group, to which the first terminal device with the association ID being 4500 belongs, is three, and the received traffic indication message is a traffic indication message corresponding to the first terminal device group, the first terminal device is not in the received terminal device group. The first terminal device continues to receive a next beacon frame and executes step 304; or when the first terminal device receives the first terminal device group and a group period four, the first terminal device may learn that the traffic indication message corresponding to the terminal device group to which the first terminal device belongs can be obtained from the third beacon frame to be transmitted later, so that the first terminal device does not need to wait to receive every beacon frame. In this way, energy saving of the terminal device is further implemented.

Step 307: According to the compression method indicated by the compression method indication information in the received traffic indication message, decompress the delivery traffic indication message in the received traffic indication message, and obtain the delivery traffic indication bit corresponding to the first terminal device.

As shown in FIG. 10, when the AID of the first terminal device is 14, and the compression method indication bit received by the first terminal device is 000, according to an indication of B1-B7 in the Bitmap Control field, it is learned that the first 16 bits in the partial virtual bitmap are all zeroes, which indicates that the access point has no indication message to transmit to the first terminal device; therefore, the first terminal device does not perform any operation on the received traffic indication message corresponding to the terminal device group to which the first terminal device belongs.

As shown in FIG. 11, when the AID of the first terminal device is 14, and the compression method indication bit received by the first terminal device is 001, the first terminal device obtains, from a first block information basic element in the received traffic indication message corresponding to the terminal device group, an offset one and a block length zero, which indicates that the access point has no indication message to transmit to the first terminal device of which the AID is 14; therefore, the first terminal device does not perform any operation on the received traffic indication message.

When the AID of the first terminal device is one, and the compression method indication bit received by the first terminal device is 001, the first terminal device obtains, from the first block information basic element in the received traffic indication message corresponding to the terminal device group, an offset one, which indicates that the access point has an indication message to transmit to the first terminal device of which the AID is one; therefore, the first terminal device obtains the corresponding delivery traffic indication message.

In addition, there may be other compression methods, which may provide different compression effects in different distribution situations of zeroes and ones in the delivery traffic indication messages corresponding to the terminal devices in each terminal device group. According to different preset compression methods, corresponding decompression operations are performed to obtain the corresponding delivery traffic indication message.

In addition, when the obtained traffic indication message corresponding to the terminal device group to which the terminal device belongs includes bit flipping indication information, and the bit flipping indication information is one, bit flipping is performed on the Bitmap obtained after the decompression to invert ones to zeroes and invert zeroes to ones, so as to obtain the corresponding delivery traffic indication information, and thereby the delivery traffic indication message of the terminal device is obtained.

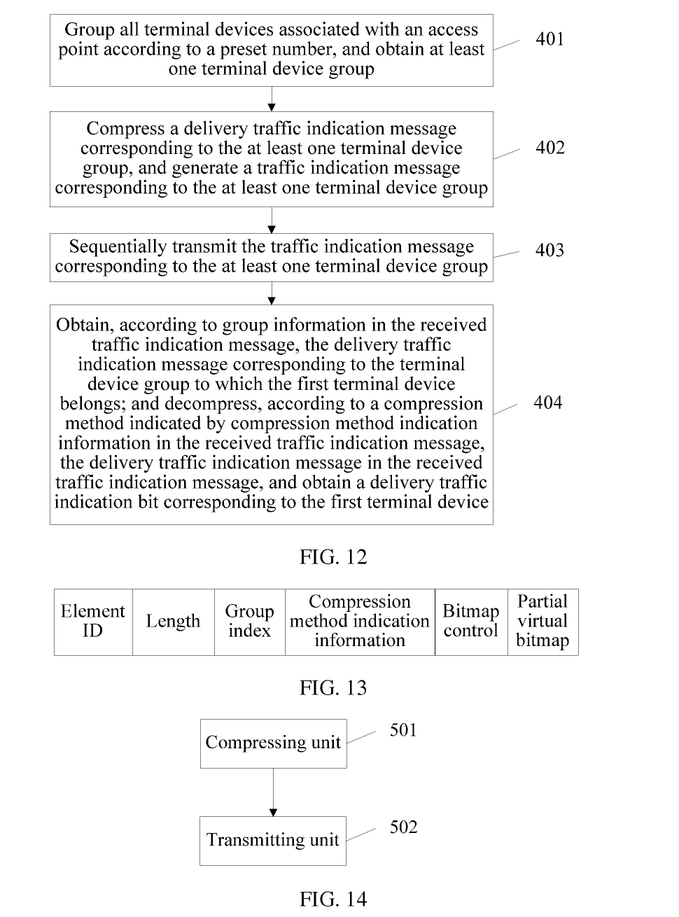

An embodiment of the present invention provides a method for transmitting a traffic indication message. As shown in FIG. 12, specific steps are shown in the following:

Step 401: Group all terminal devices associated with an access point according to a preset number, and obtain at least one terminal device group.

The access point groups the terminal devices according to a preset fixed number.

For example, every 2000 terminal devices form one group; therefore, terminal devices of which association IDs are from 1 to 2000 belong to a first terminal device group, terminal devices of which association IDs are from 2001 to 4000 belong to a second terminal device group, terminal devices of which association IDs are from 4001 to 6000 belong to a third terminal device group, and the rest can be deduced by analogy.

The existing 2007 terminal devices may form the first terminal device group, and terminal devices of which association IDs are greater than 2007 may be grouped according to a preset fixed number.

Step 402: Compress a delivery traffic indication message corresponding to the at least one terminal device group, and generate a traffic indication message corresponding to the at least one terminal device group, where the delivery traffic indication message is corresponding to one terminal device in the at least one terminal device group, and the at least one terminal device associated with the access point is specifically any terminal device in the terminal device group corresponding to the traffic indication message.

Different compression methods may be adopted to compress a delivery traffic indication message corresponding to terminal devices in each terminal device group, and a compression method is indicated by compression method indication information in the traffic indication message corresponding to the terminal device group.

Step 403: Simultaneously transmit the traffic indication message corresponding to the at least one terminal device group, where the traffic indication message further includes group information, the group information is group information used for indicating the terminal device group corresponding to the traffic indication message, and the delivery traffic indication message indicates, through a delivery traffic indication bit corresponding to each terminal device in the terminal device group corresponding to the delivery traffic indication message, whether each terminal device in the terminal device group corresponding to the delivery traffic indication message has data to receive.

Specifically, traffic indication messages corresponding to all terminal device groups are included. When the first terminal device group includes the original 2007 terminal devices, the original TIM message format is adopted to transmit the traffic indication message corresponding to the terminal device group.

When the access point needs to support 6000 terminal devices, for terminal devices of which AIDs are greater than 2007, when the preset fixed number is 1999, these terminal devices are grouped and each group includes 1999 terminal devices, that is, terminal devices with AIDs from 2008 to 4007 form a group, and terminal devices with AIDs from 4008 to 6000 form another group. In this case, a second GTIM message format is adopted, and as shown in FIG. 13, newly defined fields are as follows: element ID indicates the type of a message, which is used for indicating that the message is a GTIM message; message length indicates the length of a transmitted GTIM message; group index is used for indicating a group serial number of a terminal device group and takes up eight bits; compression method indicates a method for compressing a traffic indication message in a terminal device group, and the compression method takes up two or three bits in a partial virtual bitmap; and Partial Virtual Bitmap supports at most 2014 or 2015 terminal devices.

Therefore, a beacon frame transmitted by the access point carries the original TIM message as well as a GTIM1 message and a GTIM2 message, where the group indexes of the GTIM1 message and the GTIM2 message are one and two, respectively.

For the partial virtual bitmap in each GTIM message, when the delivery traffic indication bit corresponding to each terminal device is zero, the GTIM message may not be sent.

Meanwhile, according to the indication of the compression method indication information, for example, the method shown in FIG. 10 or FIG. 11, the terminal device group may compress the delivery traffic indication message corresponding to each terminal device in the traffic indication message corresponding to the terminal device group.

In addition, there may be other compression methods, which may provide different compression effects in different distribution situations of zeroes and ones in the delivery traffic indication messages corresponding to the terminal devices in each terminal device group. Therefore, in order to increase the compression efficiency, different compression methods may be adopted for different terminal device groups, so as to achieve the best compression effect.

Meanwhile, as shown in FIG. 10 and FIG. 11, the transmitted traffic indication message corresponding to the terminal device group further includes bit flipping indication information, used for indicating whether bit flipping is performed on the delivery traffic indication bit in the delivery traffic indication message.

Step 404: When the traffic indication message received by the first terminal device is a traffic indication message corresponding to at least two terminal device groups, obtain, according to the group information in the received traffic indication message, the delivery traffic indication message corresponding to the terminal device group to which the first terminal device belongs; and decompress, according to the compression method indicated by the compression method indication information in the received traffic indication message, the delivery traffic indication message in the received traffic indication message, and obtain the delivery traffic indication bit corresponding to the first terminal device.

For example, the traffic indication message corresponding to the terminal device group to which the terminal device belongs is obtained according to the association ID and the group index of the terminal device group.

The terminal device obtains the delivery traffic indication message corresponding to the terminal device from the decompressed delivery traffic indication messages corresponding to the terminal devices.

For a terminal device of which an association ID is greater than 2007, a group index of a terminal device group to which the terminal device belongs may be obtained by: subtracting 2007 from the association ID of the terminal device to obtain a value, dividing the obtained value by 1999 to obtain a quotient, rounding the quotient to obtain an integer, and adding one to the integer.

When the traffic indication message corresponding to the terminal device group to which the terminal device belongs is obtained, a corresponding decompression operation is performed according to the obtained compression method as shown in FIG. 10 or FIG. 11.

In addition, when the obtained traffic indication message corresponding to the terminal device group to which the terminal device belongs includes bit flipping indication information, and the bit flipping indication information is one, bit flipping is performed on the Bitmap obtained after the decompression to invert ones to zeroes and invert zeroes to ones, so as to obtain the corresponding delivery traffic indication information, and thereby the delivery traffic indication message of the terminal device is obtained.

When the terminal device does not find the terminal device group to which the terminal device belongs in the received beacon frame, which indicates that the terminal devices in the group do not have data to transmit, the terminal device does not have data to receive.

### Embodiment 4

An embodiment of the present invention provides an access point. As shown in FIG. 14, the access point includes a compressing unit 501 and a transmitting unit 502, where the compressing unit 501 is configured to compress a delivery traffic indication message and generate a traffic indication message, where the delivery traffic indication message is used for indicating whether at least one terminal device associated with an access point has data to receive, and the delivery traffic indication message indicates, through a delivery traffic indication bit corresponding to the at least one terminal device, whether the at least one terminal device has data to receive; and the transmitting unit 502 is configured to transmit the traffic indication message, where the traffic indication message includes compression method indication information and the compressed delivery traffic indication message, and the compression method indication information is used for indicating a compression method adopted to compress the delivery traffic indication message.

In an embodiment, the compressing unit 501 is specifically configured to encode a bitmap of the delivery traffic indication bit.

In an embodiment, the traffic indication message transmitted by the transmitting unit 502 further includes bit flipping indication information, used for indicating whether bit flipping is performed on the delivery traffic indication bit in the delivery traffic indication message.

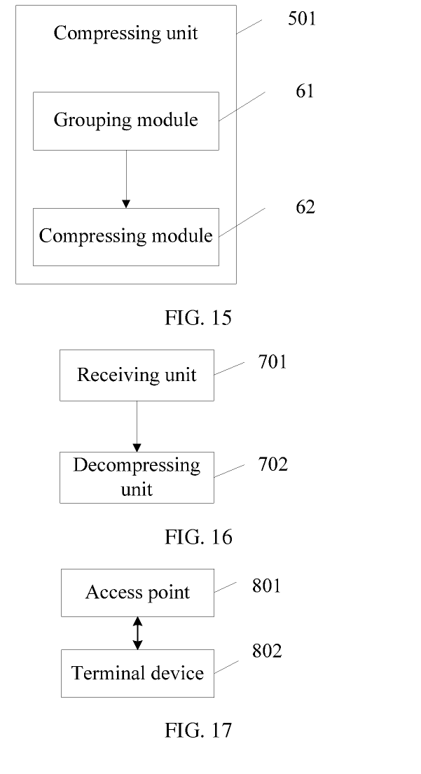

In an embodiment, as shown in FIG. 15, the compressing unit 501 further includes: a grouping module 61 configured to group all the terminal devices associated with the access point according to a preset number and obtain at least one terminal device group; a compressing module 62 configured to compress the delivery traffic indication message corresponding to the at least one terminal device group, and generate the traffic indication message corresponding to the at least one terminal device group, where the delivery traffic indication message is corresponding to one terminal device in the at least one terminal device group, and the at least one terminal device associated with the access point is specifically any terminal device in the terminal device group corresponding to the traffic indication message.

At this time, the transmitting unit is specifically configured to: transmit the traffic indication message corresponding to the at least one terminal device group, where the traffic indication message further includes group information, the group information is group information used for indicating the terminal device group corresponding to the traffic indication message, and the delivery traffic indication message indicates, through the delivery traffic indication bit corresponding to each terminal device in the terminal device group corresponding to the delivery traffic indication message, whether each terminal device in the terminal device group corresponding to the delivery traffic indication message has data to receive.

The transmitting unit is configured to sequentially transmit the traffic indication message corresponding to the at least one terminal device group; or simultaneously transmit the traffic indication message corresponding to the at least one terminal device group.

An embodiment of the present invention provides a terminal device. As shown in FIG. 16, the terminal device includes a receiving unit 701 and a decompressing unit 702, where the receiving unit 701 is configured to receive a traffic indication message, where the traffic indication message includes compression method indication information and a compressed delivery traffic indication message corresponding to at least one terminal device associated with an access point, the compression method indication information is used for indicating a compression method adopted to compress the delivery traffic indication message corresponding to the at least one terminal device, and the delivery traffic indication message indicates, through a delivery traffic indication bit, whether the at least one terminal device has data to receive; and the decompressing unit 702 is configured to decompress, according to the compression method indicated by the compression method indication information in the received traffic indication message, the delivery traffic indication message in the received traffic indication message, and obtain the delivery traffic indication bit corresponding to the terminal device.

In an embodiment, the decompressing unit is specifically configured to decode a bitmap of the delivery traffic indication bit.

In an embodiment, the traffic indication message received by the receiving unit further includes bit flipping indication information, used for indicating whether bit flipping is performed on the delivery traffic indication bit in the delivery traffic indication message.

The traffic indication message received by the receiving unit may further include group information of the terminal device group. The group information is group information used for indicating the terminal device group, and the traffic indication message is corresponding to the terminal device group. The at least one terminal device associated with the access point is specifically any terminal device in the terminal device group corresponding to the traffic indication message.

In an embodiment, the receiving unit is specifically configured to: when the traffic indication message received by the receiving unit is a traffic indication message corresponding to one terminal device group, determine, according to the group information in the received traffic indication message, whether the received traffic indication message is the traffic indication message corresponding to the terminal device group to which the terminal device belongs; when it is determined that the traffic indication message received by the receiving unit is the traffic indication message corresponding to the terminal device group to which the terminal device belongs, decompress, according to the compression method indicated by the compression method indication information in the received traffic indication message, the delivery traffic indication message in the received traffic indication message; or when it is determined, according to the group information in the received traffic indication message, that the traffic indication message received by the receiving unit is not the traffic indication message corresponding to the terminal device group to which the terminal device belongs, continue to receive a traffic indication message corresponding to a next terminal device group; or predict, according to the group information in the received traffic indication message, a beacon frame of the traffic indication message corresponding to the terminal device group to which the terminal device belongs, and obtain the beacon frame at the moment when the beacon frame is sent.

In an embodiment, the receiving unit is specifically configured to: when the traffic indication message received by the receiving unit is the traffic indication message corresponding to at least two terminal device groups, obtain, according to the group information in the received traffic indication message, the delivery traffic indication message corresponding to the terminal device group to which the terminal device belongs; and decompress, according to the compression method indicated by the compression method indication information in the received traffic indication message, the delivery traffic indication message in the received traffic indication message.

An embodiment of the present invention provides a system for transmitting a traffic indication message. As shown in FIG. 17, the system includes an access point 801 and a terminal device 802, where the access point 801 may be the access point composed of the compressing unit 501 and the transmitting unit 502 shown in FIG. 14, or composed of the compressing unit including the grouping module 61 and the compressing module 62 shown in FIG. 15 and the transmitting unit 502 shown in FIG. 14; and the terminal device 802 may be the terminal device composed of the receiving unit 701 and the decompressing unit 702 shown in FIG. 16.

In the apparatus and system for transmitting a traffic indication message provided by the embodiments of the present invention, the access point groups the terminal devices to obtain the at least one terminal device group, compresses, according to the preset compression method, the delivery traffic indication message corresponding to each terminal device in the traffic indication message corresponding to the terminal device group, and transmits the traffic indication message which includes the compressed delivery traffic indication message, where the adopted transmitting manner includes: sequentially transmitting the traffic indication message corresponding to the at least one terminal device group or simultaneously transmitting the traffic indication message corresponding to the at least one terminal device group. In this way, when a single AP supports more than 2007 STAs, a problem that a TIM message is too long is solved, the TIM message is effectively compressed, and the length of the TIM message is reduced; therefore, the length of a beacon frame is reduced, and the transmission efficiency is increased.

The above method, apparatus, and system are more applicable to application scenarios where the number of terminal devices, such as smart meters and machine to machine (M2M) is large and the amount of data is small, so that a single AP supports more terminal devices in these application scenarios.

The technologies, system, apparatus, and method, respectively, illustrated in the above embodiments and the technical features, respectively, illustrated in the embodiments may be combined, so as to produce other modules, methods, apparatuses, systems, and technologies without departing from the spirit and principle of the present invention, and the modules, methods, apparatuses, systems, and technologies produced according to the embodiments of the present invention shall fall within the protection scope of the present invention.

Apparently, a person skilled in the art should understand that the units or steps in the present invention may be implemented by a universal computing apparatus. The units or steps may be integrated in a single computing apparatus, or may be distributed in a network composed of multiple computing apparatuses. Optionally, the units or steps may be implemented through program code which is executable to a computing apparatus, so that the units or steps may be stored in a storage device (such as a magnetic disk, an optical disc, a read-only memory, a random access memory, or a flash memory) to be executed by a computing apparatus. Alternatively, the units or steps may be, respectively, made into multiple circuit modules, or multiple units or steps in the units or steps may be made into a single circuit module so as to be implemented. Therefore, the present invention is not limited to any particular combination of hardware and software.

The foregoing descriptions are merely specific embodiments of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A method for transmitting a traffic indication message, comprising:
compressing a delivery traffic indication message, wherein the delivery traffic indication message indicates whether at least one terminal device associated with an access point has data to receive, wherein the delivery traffic indication message indicates, through a delivery traffic indication bit that corresponds to the at least one terminal device, whether the at least one terminal device has data to receive;
generating the traffic indication message; and
transmitting the traffic indication message, wherein the traffic indication message comprises a compression method indication information and the compressed delivery traffic indication message, and wherein the compression method indication information indicates a compression method adopted to compress the delivery traffic indication message.

2. The method according to claim 1, wherein the compressing the delivery traffic indication message comprises encoding a bitmap of the delivery traffic indication bit.

3. The method according to claim 1, wherein the traffic indication message further comprises a bit inverting indication information that indicates whether bit inverting is performed on the delivery traffic indication bit in the delivery traffic indication message.

4. The method according to claim 1, wherein the compressing the delivery traffic indication message comprises:
grouping all of the terminal devices associated with the access point according to a preset number;
obtaining at least one terminal device group; and
compressing the delivery traffic indication message corresponding to the at least one terminal device group,
wherein the generating the traffic indication message comprises generating the traffic indication message corresponding to the at least one terminal device group,
wherein the delivery traffic indication message corresponds to one terminal device in the at least one terminal device group,
wherein the at least one terminal device associated with the access point is any terminal device in the terminal device group that corresponds to the traffic indication message, and
wherein the transmitting the traffic indication message comprises transmitting the traffic indication message that corresponds to the at least one terminal device group,
wherein the traffic indication message further comprises a group information that indicates the terminal device group that corresponds to the traffic indication message, and
wherein the delivery traffic indication message indicates, through a delivery traffic indication bit that corresponds to each terminal device in the terminal device group that corresponds to the delivery traffic indication message, whether each of the terminal devices in the terminal device group that corresponds to the delivery traffic indication message has data to receive.

5. The method according to claim 4, wherein the transmitting the traffic indication message corresponding to the at least one terminal device group comprises:
either sequentially transmitting the traffic indication message corresponding to the at least one terminal device group; or
simultaneously transmitting the traffic indication message corresponding to the at least one terminal device group.

6. A method for receiving a traffic indication message, comprising:
receiving, by a first terminal device, a traffic indication message, wherein the traffic indication message comprises a compression method indication information and a compressed delivery traffic indication message that corresponds to at least one terminal device associated with an access point, wherein the compression method indication information indicates a compression method adopted to compress the delivery traffic indication message that corresponds to the at least one terminal device, wherein the delivery traffic indication message indicates, through a delivery traffic indication bit, whether the at least one terminal device has data to receive;
decompressing, according to the compression method indicated by the compression method indication information in the received traffic indication message, the delivery traffic indication message in the received traffic indication message; and
obtaining the delivery traffic indication bit corresponding to the first terminal device.

7. The method according to claim 6, wherein the decompressing, according to the compression method indicated by the compression method indication information in the received traffic indication message, the delivery traffic indication message in the received traffic indication message comprises decoding a bitmap of the delivery traffic indication bit.

8. The method according to claim 6, wherein the traffic indication message further comprises a bit inverting indication information that indicates whether bit inverting is performed on the delivery traffic indication bit in the delivery traffic indication message.

9. The method according to claims 6, wherein the traffic indication message further comprises a group information of a terminal device group, wherein the group information is group information used for indicating the terminal device group, wherein the traffic indication message corresponds to the terminal device group, and wherein the at least one terminal device associated with the access point is any terminal device in the terminal device group corresponding to the traffic indication message.

10. The method according to claim 9, wherein the decompressing, according to the compression method indicated by the compression method indication information in the received traffic indication message, the delivery traffic indication message in the received traffic indication message comprises:
determining, according to the group information in the received traffic indication message, whether the traffic indication message is the traffic indication message corresponding to the terminal device group to which the first terminal device belongs when the traffic indication message received by the first terminal device is a traffic indication message that corresponds to the terminal device group;
decompressing, according to the compression method indicated by the compression method indication information in the received traffic indication message, the delivery traffic indication message in the received traffic indication message when the traffic indication message received by the first terminal device is the traffic indication message that corresponds to the terminal device group to which the first terminal device belongs;
either continuing to receive a traffic indication message corresponding to a next terminal device group when the received traffic indication message is not the traffic indication message corresponding to the terminal device group to which the first terminal device belongs according to the group information in the received traffic indication message; or
predicting, according to the group information in the received traffic indication message, a beacon frame of the traffic indication message corresponding to the terminal device group to which the first terminal device belongs; and
obtaining the beacon frame at the moment when the beacon frame is sent.

11. The method according to claim 9, wherein the decompressing, according to the compression method indicated by the compression method indication information in the received traffic indication message, the delivery traffic indication message in the received traffic indication message comprises:
obtaining, according to the group information in the received traffic indication message, the delivery traffic indication message corresponding to the terminal device group to which the first terminal device belongs when the traffic indication message received by the first terminal device is a traffic indication message corresponding to at least two terminal device groups; and
decompressing, according to the compression method indicated by the compression method indication information in the received traffic indication message, the delivery traffic indication message in the received traffic indication message.

12. An access point, comprising:
a compressing unit configured to compress a delivery traffic indication message, wherein the delivery traffic indication message indicates whether at least one terminal device associated with the access point has data to receive, wherein the delivery traffic indication message indicates, through a delivery traffic indication bit corresponding to the at least one terminal device, whether the at least one terminal device has data to receive;
generate a traffic indication message; and
a transmitting unit configured to transmit the traffic indication message, wherein the traffic indication message comprises compression method indication information and the compressed delivery traffic indication message, and wherein the compression method indication information indicates a compression method adopted to compress the delivery traffic indication message.

13. The access point according to claim 12, wherein the compressing unit is configured to encode a bitmap of the delivery traffic indication bit.

14. The access point according to claim 12, wherein the traffic indication message transmitted by the transmitting unit further comprises bit inverting indication information that indicates whether bit inverting is performed on the delivery traffic indication bit in the delivery traffic indication message.

15. The access point according to claim 12, wherein the compressing unit comprises:
a grouping module configured to group all of the terminal devices associated with the access point according to a preset number and obtain at least one terminal device group; and
a compressing module configured to compress the delivery traffic indication message corresponding to the at least one terminal device group and generate the traffic indication message corresponding to the at least one terminal device group, wherein the delivery traffic indication message corresponds to one terminal device in the at least one terminal device group, wherein the at least one terminal device associated with the access point is any terminal device in the terminal device group that corresponds to the traffic indication message,
wherein the transmitting unit is configured to transmit the traffic indication message that corresponds to the at least one terminal device group, wherein the traffic indication message further comprises a group information that indicates the terminal device group that corresponds to the traffic indication message, and wherein the delivery traffic indication message indicates, through the delivery traffic indication bit that corresponds to each of the terminal devices in the terminal device group that corresponds to the delivery traffic indication message, whether each terminal device in the terminal device group that corresponds to the delivery traffic indication message has data to receive.

16. The access point according to claim 15, wherein the transmitting unit is configured to: either sequentially transmit the traffic indication message corresponding to the at least one terminal device group or simultaneously transmit the traffic indication message corresponding to the at least one terminal device group.

17. A terminal device, comprising:
a receiving unit configured to receive a traffic indication message, wherein the traffic indication message comprises a compression method indication information and a compressed delivery traffic indication message that corresponds to at least one terminal device associated with an access point, wherein the compression method indication information indicates a compression method adopted to compress the delivery traffic indication message that corresponds to the at least one terminal device, wherein the delivery traffic indication message indicates, through a delivery traffic indication bit, whether the at least one terminal device has data to receive; and
a decompressing unit configured to decompress, according to the compression method indicated by the compression method indication information in the received traffic indication message, the delivery traffic indication message in the received traffic indication message; and
obtain the delivery traffic indication bit corresponding to the terminal device.

18. The terminal device according to claim 17, wherein the decompressing unit is configured to decode a bitmap of the delivery traffic indication bit.

19. The terminal device according to claim 17, wherein the traffic indication message received by the receiving unit further comprises a bit inverting indication information that indicates whether bit inverting is performed on the delivery traffic indication bit in the delivery traffic indication message.

20. The terminal device according to claim 17, wherein the traffic indication message received by the receiving unit further comprises a group information of a terminal device group, wherein the group information is group information used for indicating the terminal device group, wherein the traffic indication message corresponds to the terminal device group, and wherein the at least one terminal device associated with the access point is any terminal device in the terminal device group corresponding to the traffic indication message.

21. The terminal device according to claim 20, wherein the decompressing unit is configured to:
determine, according to the group information in the traffic indication message, whether the received traffic indication message is the traffic indication message corresponding to the terminal device group to which the terminal device belongs when the traffic indication message received by the receiving unit is a traffic indication message corresponding to one terminal device group;
decompress, according to the compression method indicated by the compression method indication information in the received traffic indication message, the delivery traffic indication message in the received traffic indication message when the traffic indication message received by the receiving unit is the traffic indication message corresponding to the terminal device group to which the terminal device belongs;
either continue to receive a traffic indication message corresponding to a next terminal device group when it is determined, according to the group information in the received traffic indication message, that the traffic indication message received by the receiving unit is not the traffic indication message corresponding to the terminal device group to which the terminal device belongs; or
predict, according to the group information in the received traffic indication message, a beacon frame of the traffic indication message corresponding to the terminal device group to which the terminal device belongs; and
obtain the beacon frame at the moment when the beacon frame is sent.

22. The terminal device according to claim 20, wherein the decompressing unit is configured to:
obtain, according to the group information in the received traffic indication message, the delivery traffic indication message corresponding to the terminal device group to which the terminal device belongs when the traffic indication message received by the receiving unit is a traffic indication message corresponding to at least two terminal device groups; and
decompress, according to the compression method indicated by the compression method indication information in the received traffic indication message, the delivery traffic indication message in the received traffic indication message.
